(19) United States
(12) Patent Application Publication
(10) Pub. No.: US 2003/0074575 A1
(43) Pub. Date: Apr. 17, 2003

(54) Computer or computer resource lock control device and method of implementing same

(76) Inventors: Tim M. Hoberock, Boise, ID (US); C. Troy Jensen, Caldwell, ID (US); David M. Payne, Star, ID (US)

Correspondence Address: HEWLETT-PACKARD COMPANY, Intellectual Property Administration, P.O. Box 272400, Fort Collins, CO, 80527-2400, US

(21) Appl. No.: 09/976,068

(22) Filed: Oct. 11, 2001

(51) Int. Cl. H04L 9/32

(52) U.S. Cl. 713/200

(57) ABSTRACT

A lock control device for a computer or other piece of equipment can control accesses to that equipment. The lock control device provides input to the computer or other piece of equipment to identify an authorized user. This input is in lieu of, for example, entry of one or more passwords using a keyboard. The lock control device of the present invention is preferably activated using, for example, a proximity card or a magnetic strip card. In this way, access to the equipment secured by the lock control device can be quickly activated, even if that equipment has timed out and locked up.

### FIELD OF THE INVENTION

The present invention relates the field of computer security. More particularly, the present invention relates to computers, computer terminals and resources that are accessed through a computer or computer terminal that are subject to security measures in which the computer, terminal or resource is automatically secured and locked after a measured period of inactivity requiring the user to demonstrate authorization to regain access to the computer, terminal or resource.

### BACKGROUND OF THE INVENTION

FIG. 1 illustrates an exemplary computer system. This system may be a stand-alone computer, a networked computer, or a computer terminal or workstation connected to a larger, main-frame computer. The term “computer” will hereafter be used to refer generically to stand-alone computers, networked computers, or computer terminals or workstations connected to a larger, main-frame computer.

As shown in FIG. 1, a basic computer system (100) typically comprises a monitor (101), user input devices, such as a mouse (104) and keyboard (103), and a central processing unit (102) or connection to a main-frame processor.

Computers often have automated measures designed to protect the computer and the information and resources it contains. These measures typically operate by measuring the time that the computer has gone without being used, e.g., without typing on the keyboard (103) or movement of the mouse (104).

For example, a monitor (101), particularly a cathode ray tube monitor, can be damaged if the same screen is displayed for a long period of time. The luminescent material in the screen can become depleted along the lines and shapes of images displayed for a long period of time. The result is that when the display is finally changed, a shadow of the former, long-held display still appears on the monitor.

To prevent this, tasks known commonly as screen savers are run in the background of most computing platforms. The screen saver task measures the time since the computer last received input from the user, e.g., typing on the keyboard (103) or movement of the mouse (104). If the time since the last input from the user exceeds a specified limit, the screen saver will take over the monitor (101) and display a “screen saver” which is typically an animated or dynamic display that prevents any static image from being displayed for a lengthy period of time.

Typically, by accessing the screen saver's control interface, the user can specify by amount of time the computer can be inactive before the screen saver display is implemented. This is a significant convenience as some users will want the screen saver to appear quickly if the computer is unused, while other users will not want to be bothered by the screen saver each time they stop inputting for a few moments.

Another automatic safety measure, similar to screen savers, protects sensitive or confidential information or resources that may be available on or through a computer. If a computer contains confidential information or access to sensitive or important resources, access to that computer is typically controlled by requiring any authorized user to demonstrate authorization to access the computer by logging on. This is usually done by requiring the user to enter a password or passwords to gain access to the computer and/or its resources. Any user who cannot provide the appropriate passwords will not gain access.

Another layer of protection is provided by automatically logging the user out if the computer has been inactive for a specified period of time, much like a screen saver. If an authorized user has logging into a secured computer, but not entered any input for a period of time, the concern is that the user has left or been called away without securing the computer. Consequently, if an unauthorized person can get to the computer at this time, when the computer is logged in, the unauthorized person will have full access to the confidential information or resources of the computer. This unwanted possibility is diminished by having the secured computer log out if the computer goes unused for a specified period of time.

In this context, logging out involves locking up access to the computer and its information and resources such that an authorized user will again have to log in, typically by providing one or more passwords, in order to regain access to the computer, its information and available resources. If the computer automatically locks up after a specified period of not receiving user input, the resources and information on that computer will likely be secured, even if an authorized user leaves or is called away from the computer while it is in a logged in or unlocked state.

While this automatic, timed lock out is very useful to protect confidential information and resources available on the computer, it is also of some inconvenience to authorized users. The authorized user may not appreciate having to log back in to the computer each time he or she has to leave the computer for a few minutes. Logging back in obviously takes at least a few moments to accomplish and can become an annoyance if the process has to be repeated.

Consequently, authorized users, who may be, for example, mere employees who do not have a particular stake in securing the information or resources available on a computer, will frequently seek to defeat the automatic time-out feature on their computer. For example, they may be able to deactivate the time-out feature so that the computer does not lock up even if left unused indefinitely. Alternatively, they may be able to set the time-out period for such a long length of time that it becomes almost meaningless as a way to restrict access to the computer, its information and resources.

Consequently, there is a need in the art for a means and method of securing a computer that contains confidential information or provides access to restricted resources, while at the same allowing authorized users to easily access, lock and unlock, the computer without a laborious process of entering one or more passwords to gain access each time.

### SUMMARY OF THE INVENTION

The present invention is directed to a system for controlling use of a piece of office equipment or a particular resource available through that piece of equipment. In a preferred embodiment, a system according to the present invention may include a piece of office equipment; and a lock control device connected to that piece of office equipment. The lock control device is activated by presentation of an identifier of an authorized user. The lock control device controls user operation of the office equipment by enabling operation of the office equipment or a resource available through that office equipment to the authorized user.

The office equipment so secured may be, for example, a computer or computer terminal. The lock control device may be, for example, a proximity card sensor or a magnetic card reader. Preferably, the lock control device is connected to the computer or computer terminal via a daisy chain connector that also connects one or more user input devices to the computer or computer terminal.

In other embodiments, the lock control device controls may be used under the principles of the present invention to control access to a particular application residing on the computer or accessible through the computer terminal. The lock control device of the present invention may also control access to other resources available on or through the computer or computer terminal such as a network or network server.

Preferably, the secured computer or computer terminal has a timer for timing periods during which the computer or computer terminal receives no user input. The computer or computer terminal enters a locked state upon elapse of a predetermined period during which no user input is received. An authorized user may unlock the computer or computer terminal by operating the lock control device.

The present invention is not limited to the system summarized above, but also encompasses variations of this system as well the methods of making and operating the system. For example, the present invention encompasses a method for controlling use of a piece of office equipment or a particular resource available through that piece of equipment by enabling operation of the piece of office equipment or a resource available through that office equipment to an authorized user upon presentation of an identifier of the authorized user to a lock control device connected to the piece of office equipment.

### BRIEF DESCRIPTION OF THE DRAWINGS

The accompanying drawings illustrate preferred embodiments of the present invention and are a part of the specification. Together with the following description, the drawings help to demonstrate and explain the principles of the present invention.

FIG. 1 is an exemplary conventional computer system with which the present invention could be practiced.

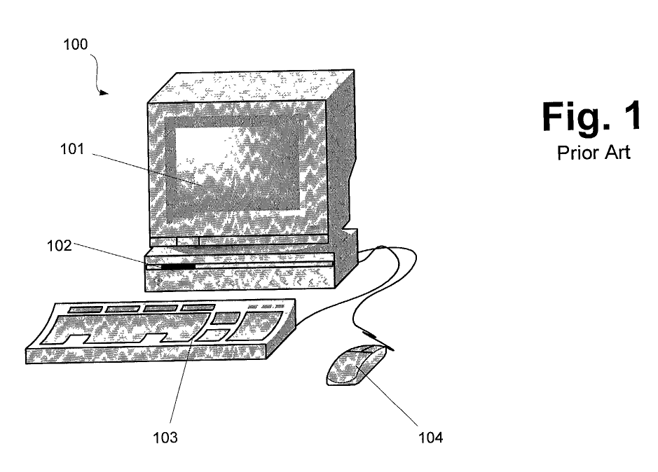

FIG. 2 is a computer system according to a first preferred embodiment of the present invention in which a proximity card system is used to unlock the computer system.

FIG. 3 is a computer system according to a second preferred embodiment of the present invention in which a magnetic strip card system is used to unlock the computer system.

FIG. 4 is a flowchart illustrating a preferred method of implementing the present invention.

FIG. 5 is an illustration of a preferred embodiment of connecting a computer lock control device to a computer according to the present invention.

FIGS. 6a and 6b illustrate embodiments of the present invention applied to control access to equipment other than a computer.

FIG. 7 illustrates a preferred embodiment of the present invention applied to controlling access to resources available on and through a computer.

Throughout the drawings, identical elements are designated by identical reference numbers.

### DETAILED DESCRIPTION OF THE PREFERRED EMBODIMENTS

The present invention provides a lock control device for a computer or other piece of equipment to control accesses to that equipment. The lock control device provides input to the computer or other piece of equipment to identify an authorized user in lieu of, for example, entry of one or more passwords using a keyboard. The lock control device of the present invention is preferably activated using, for example, a proximity card or a magnetic strip card. In this way, access to the equipment secured by the lock control device can be quickly activated, even if that equipment has timed out and locked up.

Using the drawings, the preferred embodiments of the present invention will now be explained.

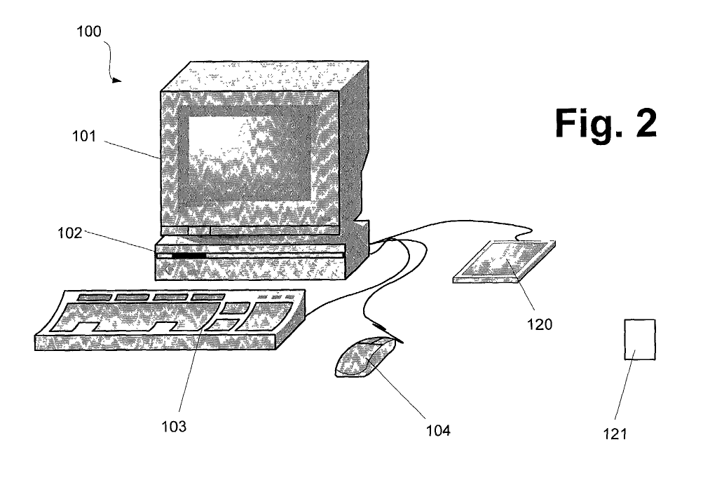

FIG. 2 illustrates a computer system according to a first preferred embodiment of the present invention in which a proximity card system is used to operate a lock control device and unlock the computer system. As above, the term “computer,” as used herein, means, without limitation, stand-alone computers, networked computers, or computer terminals or workstations connected to a larger, main-frame computer. As shown in FIG. 2, an exemplary computer system (100) may comprise a monitor (101), user input devices, such as a mouse (104) and keyboard (103), and a central processing unit (102) or connection to a main-frame processor.

The computer system (100) illustrated in FIG. 2 contains confidential information or access to restricted resources such that it is desired to control access to the system (100). Consequently, basic security measures are preferably used, such as requiring an authorized user to input one or more passwords to the computer system (100) using the keyboard (103). Additionally, once an authorized user is logged into the system, i.e., the computer system (100) is unlocked, a timer will run which measures the amount of time elapsed since the system (100) last received user input via, for example, the keyboard (103) and mouse (104). If a predetermined length of time passes without any user input while the system (100) is in an unlocked state, the system (100) will automatically log out the current user and assume a locked state such that an authorized user will again have to log in using, for example, one or more passwords entered through the keyboard (103).

However, the system (100) of FIG. 2 also includes a lock control device according to the principles of the present invention. In the example of FIG. 2, the lock control device is a proximity sensor (120) that is connected to the computer system (100). The proximity sensor (120) will detect the presence of a card (121) or other object which is encoded for detection by the sensor (120) when that card or object is brought into proximity with the sensor (120). Additionally, the proximity sensor (120) will be able to read an identifier encoded in the card (121) or other object so as to discriminate between cards.

Proximity sensors (120) and corresponding proximity cards (121) are frequently used by employers to control employee access to, for example, a building, a room, a parking garage, etc. Consequently, employees may already be carrying a proximity card which can be used to facilitate implementation of the present invention.

Under the principles of the present invention, a user can identify himself or herself to the computer system (100) by presenting his or her proximity card (121) or other object to the proximity sensor (120). As noted above, the proximity sensor (120) can distinguish between different proximity cards held by different users and can thus discriminate between different users. If a user, identified by his or her proximity card (121) being presented to the sensor (120), has authorization to use the computer system (100), the system (100) can automatically log the user in and assume an unlocked state.

If the system (100) thereafter times out and assumes a locked state, the user can regain access and unlock the system (100) by simply presenting his or her proximity card (121) to the proximity sensor (120). In this way, the user is not bothered by having to re-enter his or her passwords each time the computer system (100) times out and locks up.

As an added security precaution, the user may still be required to log in initially using one or more passwords. Then, for a period of, for example 8 hours, the user can reactivate access to the computer system (100) when the system times out by simply presenting an authorized proximity card (121) to the proximity sensor (120). Again, the user is not bothered by having to re-enter his or her passwords each time the computer system (100) times out and locks up.

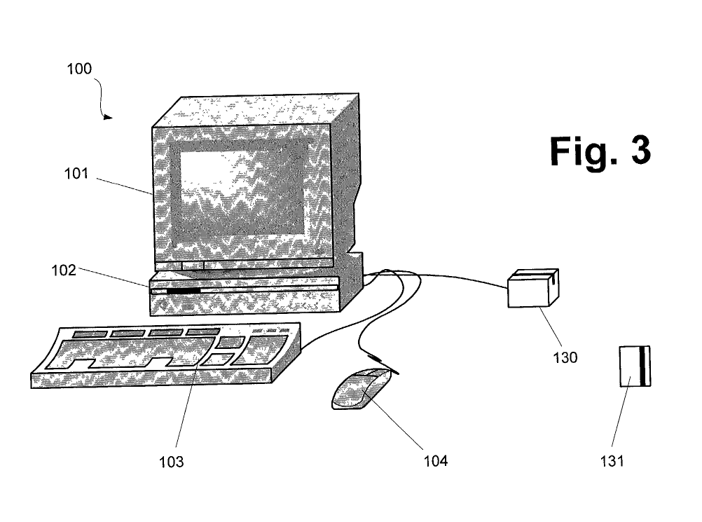

FIG. 3 illustrates a computer system according to a second preferred embodiment of the present invention in which a magnetic strip card system is used to operate a lock control device and unlock the computer system. As shown in FIG. 3, an exemplary computer system (100) may comprise a monitor (101), user input devices, such as a mouse (104) and keyboard (103), and a central processing unit (102) or connection to a main-frame processor.

As before, the computer system (100) illustrated in FIG. 3 contains confidential information or access to restricted resources such that it is desired to control access to the system (100). Consequently, basic security measures are preferably used, such as requiring an authorized user to input one or more passwords to the computer system (100) using the keyboard (103). Additionally, once an authorized user is logged into the system, i.e., the computer system (100) is unlocked, a timer will run which measures the amount of time elapsed since the system (100) last received user input via, for example, the keyboard (103) and mouse (104). If a predetermined length of time passes without any user input while the system (100) is in an unlocked state, the system (100) will automatically log out the current user and assume a locked state such that an authorized user will again have to log in using, for example, one or more passwords entered through the keyboard (103).

However, the system (100) of FIG. 3 also includes a lock control device according to the principles of the present invention. In the example of FIG. 3, the lock control device is a magnetic card reader (130) that is connected to the computer system (100). The magnetic card reader (130) will read data encoded in a magnetic strip on a card (131) when the card (131) is swiped through the reader (130) causing the magnetic strip to pass by a magnetic field detector in the card reader (130). During this process, the card reader (130) will be able to read an identifier encoded in the magnetic strip on the card (131) so as to discriminate between cards.

Magnetic card readers (130) are frequently used to read credit card numbers from credit cards, but are also less commonly used by employers to control employee access to, for example, a building, a floor, a room, a parking garage, etc. Consequently, employees may already be carrying a magnetic strip access card (131) which can be used to facilitate implementation of the present invention.

In fact, a credit card, gas card or any other magnetic strip card that the employee carries and which is unique can be used as the magnetic strip access card for the system of the present invention. For example, an authorized user could log into a computer system using a traditional password. The user the edits the access information to add quick access with a magnetic strip card. The user is then prompted to swipe any magnetic strip card (e.g., a credit card) through the reader (130). The identification data on that card is then associated with the user's authorization to access the computer or terminal which will unlock or log in when that card is again presented to the reader (130).

Under the principles of the present invention, a user can identify himself or herself to the computer system (100) by swiping his or her magnetic strip card (131) through the card reader (130). As noted above, the card reader (130) can distinguish between different magnetic strip cards held by different users and can thus discriminate between different users. If a user, identified by his or her magnetic strip card (131) as read by the reader (130), has authorization to use the computer system (100), the system (100) can automatically log the user in and assume an unlocked state.

If the system (100) thereafter times out and assumes a locked state, the user can regain access and unlock the system (100) by simply swiping his or her magnetic strip card (131) through the magnetic card reader (130). In this way, the user is not bothered by having to re-enter his or her passwords each time the computer system (100) times out and locks up.

As an added security precaution, the user may still be required to log in initially using one or more passwords. Then, for a period of, for example 8 hours, the user can reactivate access to the computer system (100) when the system times out by simply swiping an authorized magnetic strip card (131) through the card reader (130). Again, the user is not bothered by having to re-enter his or her passwords each time the computer system (100) times out and locks up.

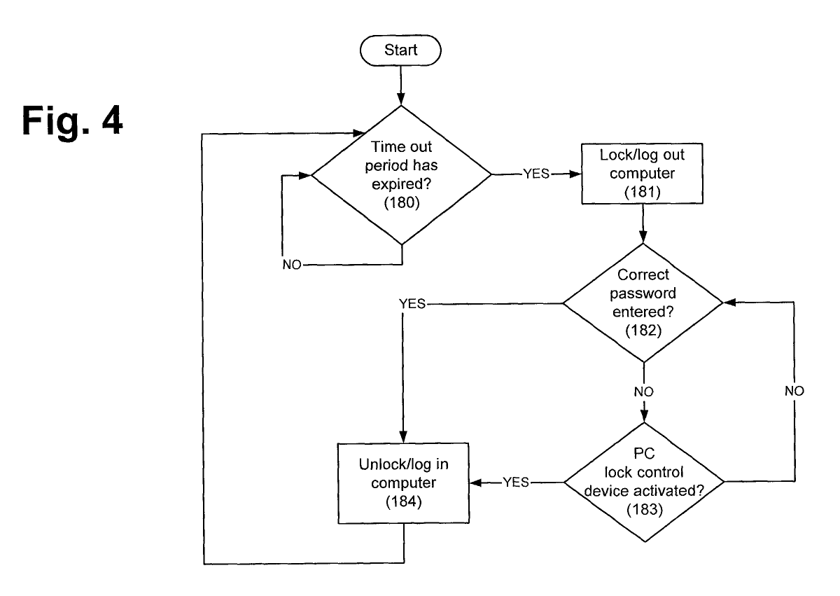

FIG. 4 is a flowchart illustrating a preferred method of implementing the present invention. As shown in FIG. 4, the secured computer system constantly monitors the time since the last user input was received, i.e., the period the system has been unused (180). When the elapsed time since the system received input exceeds a specified amount, i.e., a time out period, the computer system logs out and assumes a locked state (181).

If a user then correctly enters one or more passwords to identify himself or herself as an authorized user of the system (182), the computer system logs in (184). In other words, the computer assumes an unlocked state in which the user can access the information and resources available on or through that computer.

If no such password is entered, or was entered previously followed by the computer timing out and locking up, the user may, under the principles of the present invention, operate a lock control device (183) to gain access to the computer system. The lock control device may be, for example, a proximity sensor or a magnetic card reader consistent with the exemplary embodiments described above. If the lock control device is activated (183), e.g., an authorized card is used in the lock control device, the computer system logs in (184), i.e., the computer assumes an unlocked state in which the user can access the information and resources available on or through that computer.

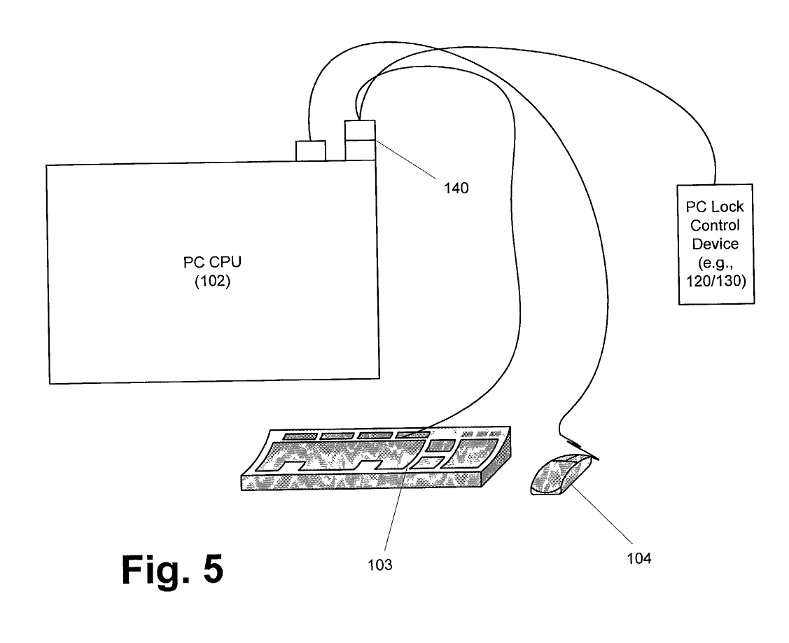

FIG. 5 is an illustration of a preferred embodiment of connecting a computer lock control device to a computer according to the present invention. The lock control device may be, for example, a proximity card sensor or a magnetic card reader as discussed in the examples above. However, the invention is not so limited as will be explained below.

As shown in FIG. 5, the lock control device (e.g., 120 or 130) is connected to the computer (102) to provide input to the computer to authorize a user who is presenting an appropriate identification card or otherwise activating the lock control device. In the preferred embodiment illustrated in FIG. 5, the lock control device is preferably connected to the computer (102) by a daisy chain (140) in common with the keyboard (103). Consequently, input from the lock control device (e.g., 120 or 130) enters the computer (102) through the same channel as would input, i.e., a password, typed on the keyboard (103). Consequently, it becomes very easy to use input from the lock control device to unlock the computer (102) in lieu of a password or similar input from the keyboard (103).

Along this line, the lock control device is not limited under the principles of the present invention to a proximity card sensor or a magnetic card reader. Rather, the lock control device can be any device that can authenticate an authorized user and provide input in lieu of a typed password to the computer. Preferably, the lock control device can be activated more rapidly than typing a password to avoid the burden on the user of needing to repeatedly log back in to the computer. For example, the lock control device could be a fingerprint scanner, a retinal scanner, a voice pattern recognition system or the like.

Consequently, under the principles of the present invention, the authorized user must present an identifier to the lock control device to access the office equipment, e.g., a computer, or resources available through that equipment. The identifier may be, as described above, a physical identifier carried by the authorized user such as a proximity card or a magnetic strip card. However, the identifier may also be a biological characteristic of the authorized user such as a fingerprint, retinal pattern or voice pattern. Any identifier of an authorized user that can be quickly tested and evaluated can be used within the principles of the present invention.

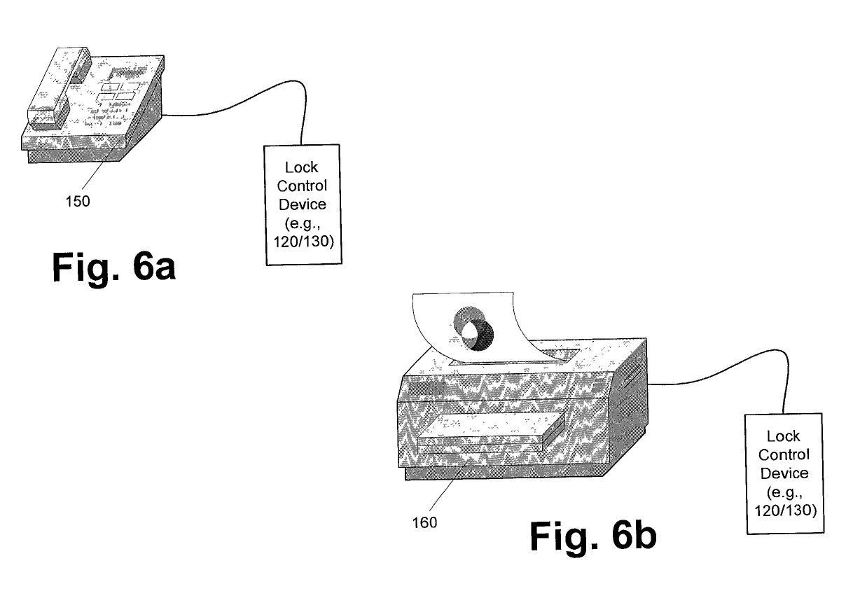

FIGS. 6a and 6b illustrate embodiments of the present invention applied to control access to equipment other than a computer. As shown in FIGS. 6a and 6b, the principles of the present invention can be applied to any piece of equipment for which access by users is to be limited and controlled.

FIG. 6a illustrates a lock control device (e.g., 120 or 130) connected to a telephone (150). Consequently, use of a particular telephone (150) could be limited to those with a card or other means of activating the lock control device (e.g., 120 or 130).

Similarly, FIG. 6b illustrates a lock control device (e.g., 120 or 130) connected to a printer (160). Consequently, user of the printer (160) can be limited to those with a card or other means of activating the lock control device (e.g., 120 or 130).

There is no limit to the type or amount of office equipment that can be secured with a lock control device (e.g., 120 or 130) according to the present invention. Examples of office equipment include, but are not limited to, computers, computer terminals, facsimile machines, copy machines, digital senders, scanners, telephones, personal digital assistants, multi-function peripherals, computer networks, servers, etc.

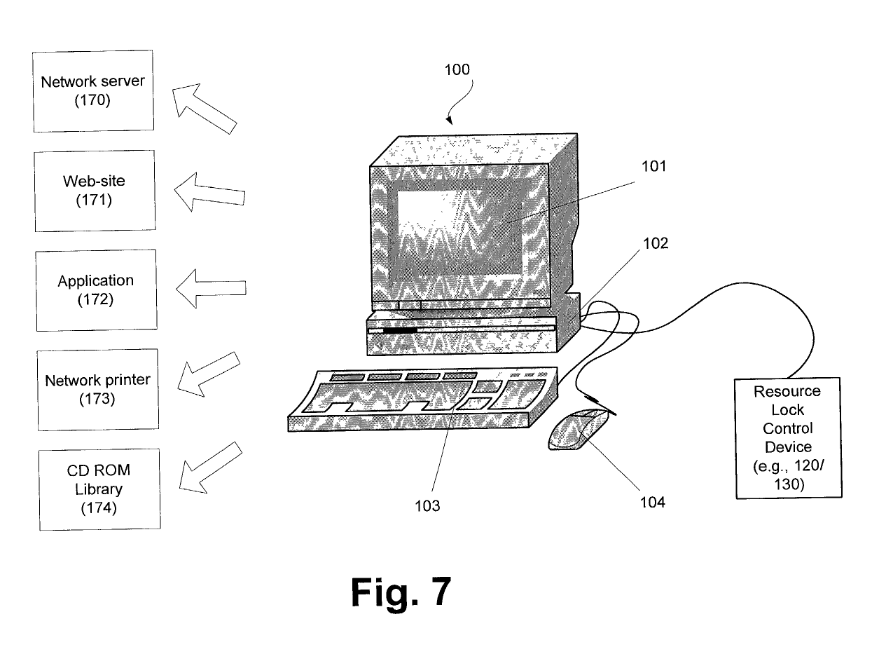

FIG. 7 illustrates another application of the present invention. As will be explained in more detail below, in addition to using the lock control device (e.g., 120 or 130) of the present invention to control user access to equipment and hardware, the lock control device (e.g., 120 or 130) of the present invention can also be applied to controlling user access to resources available on and through a computer.

It is not uncommon for a computer user, even after having logged on to the computer, to access resources through the computer that require additional verification of authorization. These resources may include particular drives or databases on a network, a particular web site, a particular application that can be run on or from the computer, etc.

As would be expected, access to these additional resources is often granted upon the entry of a password to the computer. Consequently, the present invention can be applied in a manner similar to that described above to facilitate user access to these on-line resources.

FIG. 7 illustrates such a system. As shown in FIG. 7, a computer system (100) can be used to access any number of on-line resources. These resources may include, for example, a network server (170), a particular web site (171), an application (172) that can be run on or through the computer (100), a network peripheral such as a printer (173), or a CD ROM library (174).

As shown in FIG. 7, a lock control device (e.g., 120 or 130) is connected to the computer (100). When the user desires to access any one of the restricted on-line resources (170-174), the user can demonstrate authorization to use that resource by activating the lock control device (e.g., 120 or 130) rather than having to enter a password. Similarly, if the user is using any of the on-line resources (170-174) and is timed out of that resource, i.e., the resources enters a locked state, the user can regain access to the resource by activating the lock control device (e.g., 120 or 130).

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A system for controlling use of a piece of office equipment or a particular resource available through that piece of equipment, said system comprising:
a piece of office equipment; and
a lock control device connected to said piece of office equipment, wherein said lock control device is activated by presentation of an identifier of an authorized user,
wherein said lock control device controls user operation of said office equipment by enabling operation of said office equipment or a resource available through that office equipment to said authorized user.

2. The system of claim 1, wherein said piece of office equipment is a computer or computer terminal.

3. The system of claim 1, wherein said lock control device is a proximity card sensor.

4. The system of claim 1, wherein said lock control device is a magnetic card reader.

5. The system of claim 2, wherein said lock control device is connected to said computer or computer terminal via a daisy chain connector that also connects one or more user input devices to said computer or computer terminal.

6. The system of claim 2, wherein said lock control device controls access to a particular application residing on said computer or accessible through said computer terminal.

7. The system of claim 2, further comprising a computer network with at least one network server to which said computer is connected, wherein said lock control device controls access to said network server from said computer.

8. The system of claim 2, wherein:
said computer or computer terminal further comprises a timer for timing periods during which said computer or computer terminal receives no user input;
said computer or computer terminal entering a locked state upon elapse of a predetermined period during which no user input is received; and
an authorized user may unlock said computer or computer terminal by operating said lock control device.

9. A method for controlling use of a piece of office equipment or a particular resource available through that piece of equipment, said method comprising:
enabling operation of said piece of office equipment or a resource available through that office equipment to an authorized user upon presentation of an identifier of said authorized user to a lock control device connected to said piece of office equipment.

10. The method of claim 9, wherein said piece of office equipment is a computer or computer terminal.

11. The method of claim 9, further comprising using a proximity card sensor as said lock control device.

12. The method of claim 9, further comprising using a magnetic card reader as said lock control device.

13. The method of claim 10, further comprising connecting lock control device to said computer or computer terminal via a daisy chain connector that also connects one or more user input devices to said computer or computer terminal.

14. The method of claim 10, further comprising accessing a particular application residing on said computer or accessible through said computer terminal by presenting an identifier of said authorized user to a lock control device.

15. The method of claim 10, further comprising accessing a network server on a computer network to which said computer is connected by presenting an identifier of said authorized user to a lock control device.

16. The method of claim 10, further comprising:
timing periods during which said computer or computer terminal receives no user input;
locking up or logging out said computer upon elapse of a pre-determined period during which no user input is received; and
unlocking or logging in said computer upon operation of said lock control device.

17. A system for controlling use of a piece of office equipment or a particular resource available through that piece of equipment, said system comprising:
means for testing a physical or biological identifier of an authorized user, said means for testing being electrically connected to said piece of office equipment; and
means for enabling operation of said piece of office equipment or a resource available through that office equipment to an authorized user upon successful presentation of said identifier to said means for testing.

18. The system of claim 17, wherein said piece of office equipment is a computer or computer terminal.

19. The system of claim 17, wherein said means for testing is a proximity card sensor and said physical identifier is a proximity card.

20. The system of claim 17, wherein said means for testing is a magnetic card reader and said physical identifier is a magnetic strip card.
